(19) United States
(12) Patent Application Publication
(10) Pub. No.: US 2014/0093333 A1
(43) Pub. Date: Apr. 3, 2014

(54) Book Coil Binding Machine

(71) Applicant: Chou-Chih Chiang, Taichung City (TW)

(72) Inventor: Chou-Chih Chiang, Taichung City (TW)

(73) Assignee: Chung Sheen Technology Co.,Ltd

(21) Appl. No.: 13/633,119

(22) Filed: Oct. 1, 2012

(51) Int. Cl. B42C 13/00

(52) U.S. Cl. CPC B42C 13/00
USPC 412/38

(57) ABSTRACT

A book coil binding machine includes a housing, a coil guiding block, a conveying device, a clamping device, a supporting apparatus and a cutting apparatus. The coil guiding block is removably disposed on the housing. The conveying device drives a coil moving forwards along the coil guiding block. The clamping device clamps the book in the book clamping space for the coil being guided into the holes of the book when the clamping device is at the clamping position. The clamping device releases the book when the clamping device is at the releasing position. The supporting apparatus is provided for the book in the book clamping space being abutted thereto when the supporting apparatus is at a supporting position, whereas the supporting apparatus is departed from the book when the supporting apparatus is at a loosening position. The cutting apparatus cuts off the two ends of the coil which are extended out of the book when the cutting apparatus is at a cutting position.

### BACKGROUND OF THE INVENTION

1. Field of the Invention

The present invention relates to a book binding instrument. More particularly, the present invention relates to a book coil binding machine.

2. Description of the Prior Art

It is well-known for books, in particular, the loose-leaf books, holes are perforated on a side of the books and equipped with the spiral coil for the convenience of page turning and paper tearing.

Conventionally, in the procedures of equipping the coil into the books, the cutting for the coil is performed in advance according to the dimensions of the books. After the coil is cut with the predetermined length, the coil would be then manually passed through the holes of the books one by one. However, since the books are printed in large quantities, the manual operations must delay the binding procedures and be disadvantageous to mass production.

Thus, in the market, there are machines which are able to bind the coils into the books automatically. However, the machines still have disadvantages of the complicated structure and the unfavorable working efficiency and yield, which should be improved.

### SUMMARY OF THE INVENTION

The objective of this invention is to provide a book coil binding machine which is capable of automatically binding the coils into the books.

Another objective of this invention is to provide a book coil binding machine which is able to enhance the efficiency of binding the books with the coils.

Further an objective of this invention is to provide a book coil binding machine which is able to enhance the yield of binding the books with the coils.

Yet an objective of this invention is to provide a book coil binding machine which has a simple structure, low manufacturing costs and easy operations.

To achieve the aforesaid objectives, the book coil binding machine comprises:

a housing having a guiding comb tooth;

a coil guiding block being removably disposed on the housing and being formed with a spiral groove on the outer peripheral surface thereof;

a conveying device being disposed on the housing to drive a coil moving forwards along the guiding comb tooth and the spiral groove; a clamping device having a book clamping space for accommodating a book, wherein the clamping device is capable of reciprocatedly moving between a clamping position and a releasing position so as to clamp the book in the book clamping space for the coil being guided into the holes of the book when the clamping device is at the clamping position and to release the book in the book clamping space when the clamping device is at the releasing position;

a supporting apparatus being disposed on the housing and pivotally swinging between a supporting position and a loosening position, wherein the supporting apparatus is provided for the book in the book clamping space being abutted thereto when the supporting apparatus is at the supporting position, and the supporting apparatus is departed from the book in the book clamping space when the supporting apparatus is at the loosening position;

a cutting apparatus being disposed on the housing, wherein the cutting apparatus is capable of reciprocatedly moving between a cutting position and a preparing position, wherein the cutting apparatus cuts off the two ends of the coil which are extended out of the book when the cutting apparatus is at the cutting position.

### BRIEF DESCRIPTION OF THE DRAWINGS

The drawings disclose an illustrative embodiment of the present invention which serves to exemplify the various advantages and objects hereof, and are as follows:

FIG. 1 is the perspective and partial view illustrating the preferred embodiment of the present invention.

FIG. 2 is a lateral view of the embodiment shown in FIG. 1.

FIG. 3 is the structural lateral view showing the coil in the embodiment shown in FIG. 2 in a smaller scale.

FIG. 4 is a perspective view showing the coil guiding block and the coil.

FIG. 5 is a perspective view showing the coiling entering the coil guiding block and contacting with the coil sensor.

FIG. 5A is the partial enlarged view illustrating the embodiment as shown in FIG. 5.

FIG. 6 is a three dimensional and partial perspective view showing the clamping device.

FIG. 7 is a rear three dimensional view showing the clamping device.

FIG. 8 is a lateral view showing the clamping device.

FIG. 9 is a structural view showing the clamping device and the supporting apparatus.

FIG. 10 is a perspective view showing the supporting apparatus at the loosening position.

FIG. 11 is a perspective view showing the supporting apparatus at the supporting position.

FIGS. 12-13 are the perspective views showing the cutting apparatus 7.

FIG. 13A is the partial enlarged view illustrating the embodiment as shown in FIG. 13.

FIG. 14 is a front elevational view of FIG. 12,

FIG. 15 is a perspective view showing the cutting base, the cutter and the synchronous motor.

FIG. 16 is a view showing the adjustment for the scale of the conveying space by adjusting the fastening frame and the housing so as to adjust the friction wheel and the inclined guiding comb tooth.

FIG. 17 is a view showing the end of the coil contacting with the coil sensor to stop the friction wheel.

FIG. 17A is the partial enlarged view illustrating the embodiment as shown in FIG. 17.

FIG. 18 is a perspective view showing the book being disposed in the clamping device of the book clamping device.

FIG. 19 is a view showing that the user moves the book to contact with the book clamping sensor.

FIG. 19A is the partial enlarged view illustrating the embodiment as shown in FIG. 19.

FIG. 20 is a view showing that the movable pressing board being driven by the book clamping base and the magnet driver to move from the loosening position to the clamping position.

FIG. 21 is a view showing that the cam assembly receives the external force to adjust the scale of the book clamping space.

FIG. 22 is a view showing the cutting apparatus at the preparing position.

FIG. 23 is a view showing that the cutting apparatus moves from the preparing position to the cutting position.

FIG. 24 shows the book being bound with the coil that the elevating base of the supporting apparatus moves to the loosening position for the book being slit from the book clamping space.

### DETAILED DESCRIPTION OF THE PREFERRED EMBODIMENT

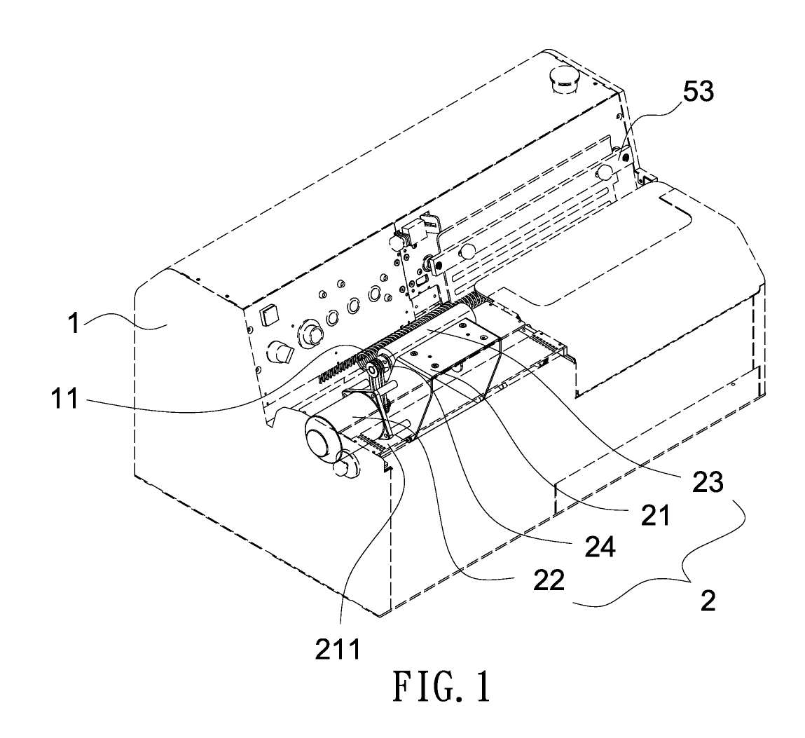

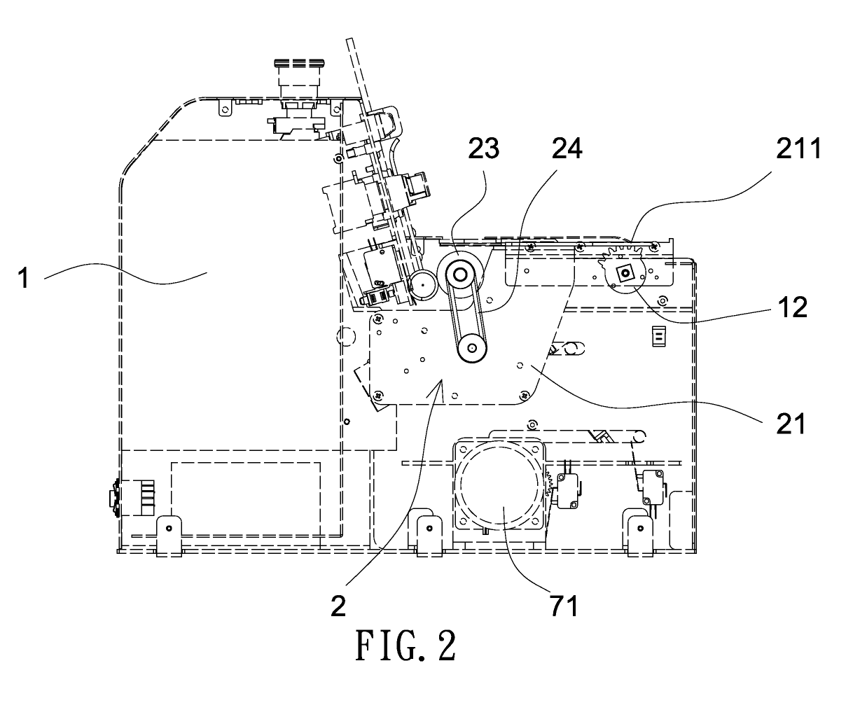

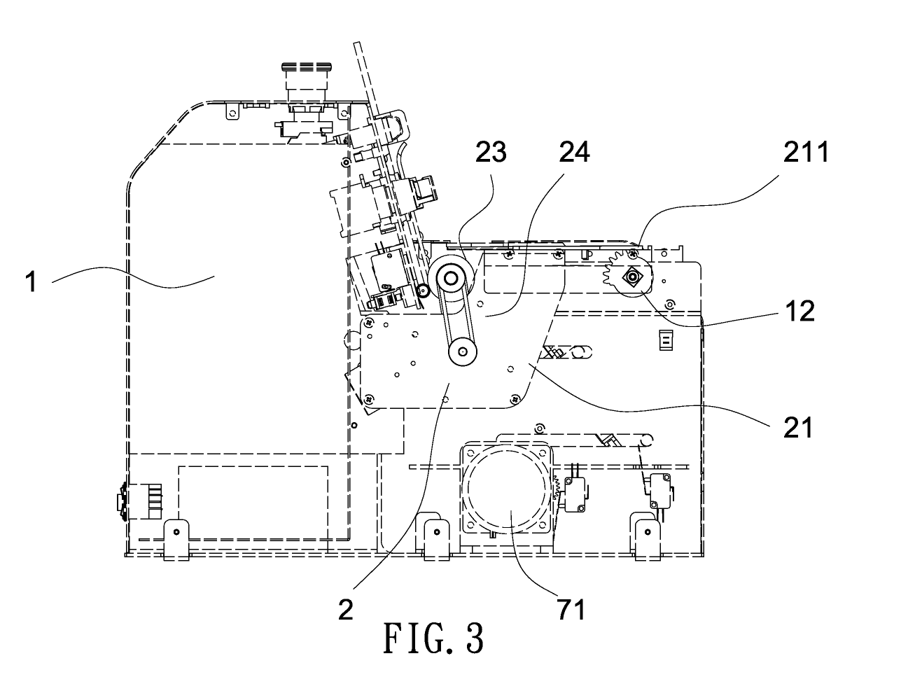

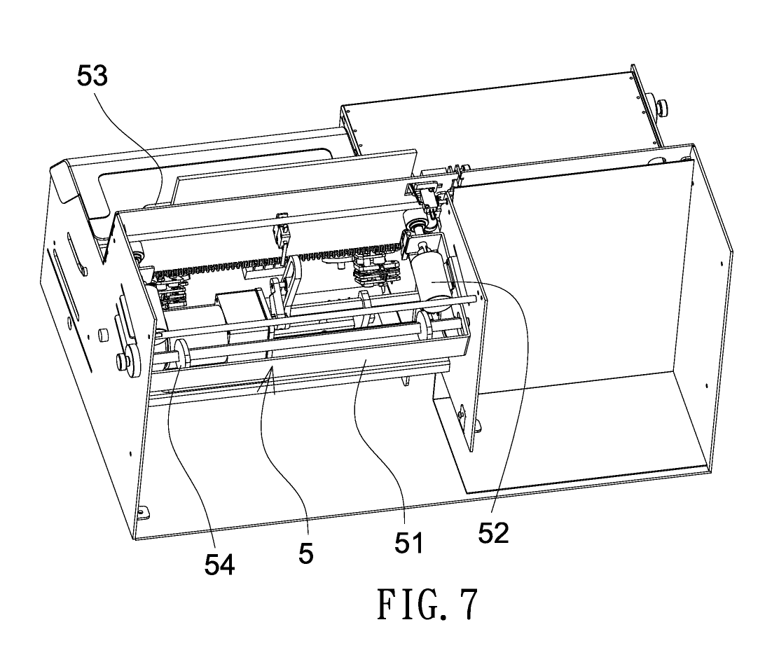

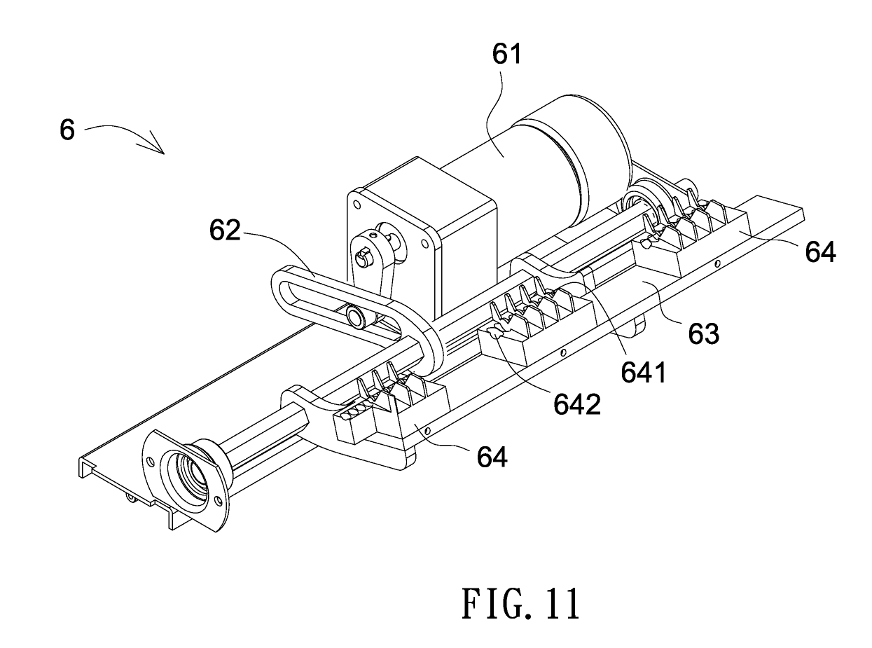

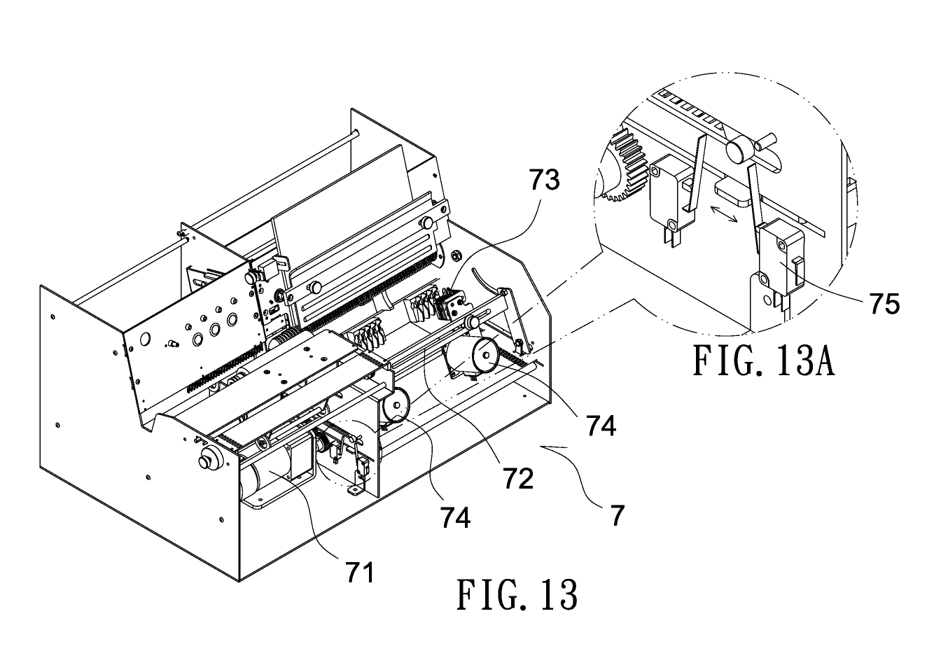

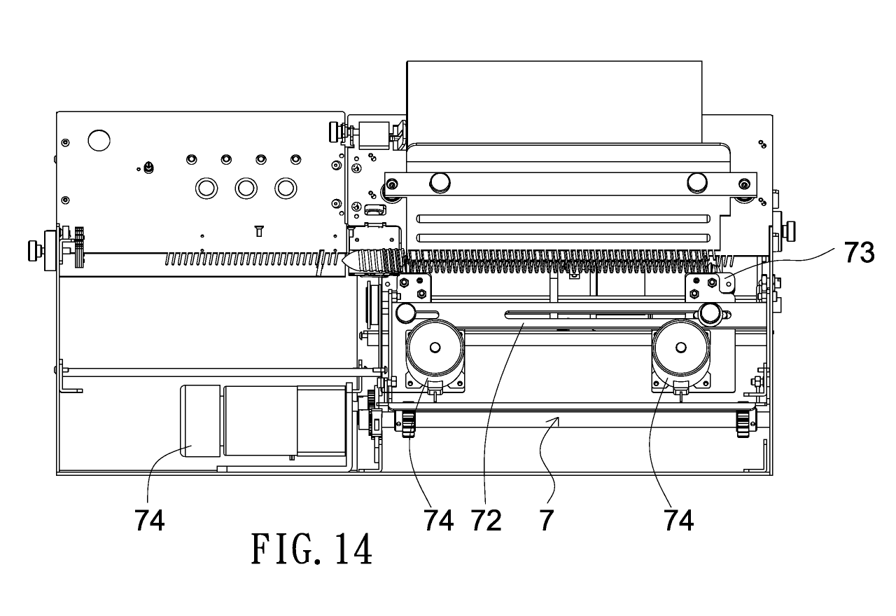

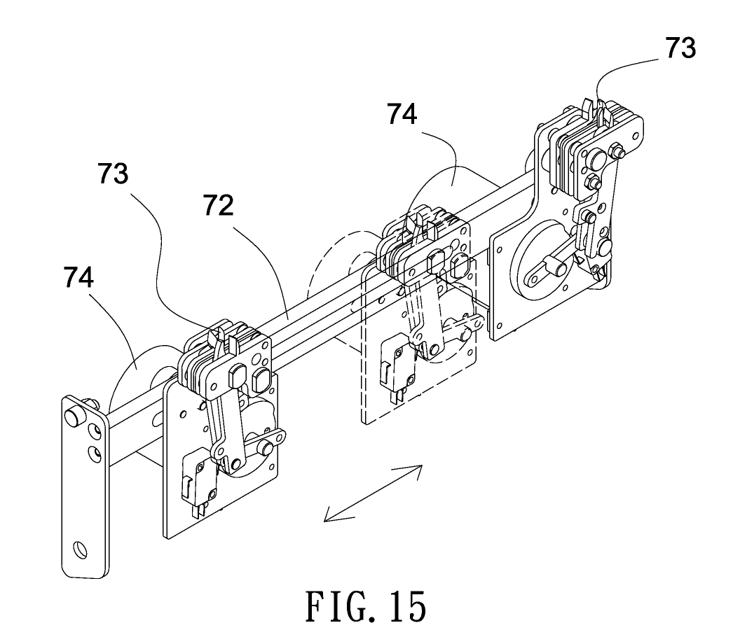

Referring to FIGS. 1-21, a preferred embodiment of the present invention provides a book coil binding machine, which comprises a housing 1, a conveying device 2, a coil guiding block 3, a coil sensor 4, a clamping device 5, a supporting apparatus 6 and a cutting apparatus 7.

Referring to FIGS. 1-3, the housing 1 is firmly disposed on a flat surface, e.g. the ground. The housing 1 has an inclined guiding comb tooth 11 and a limit gear 12 which is able to pivotally rotate without displacements which are located at the left side of the housing 1.

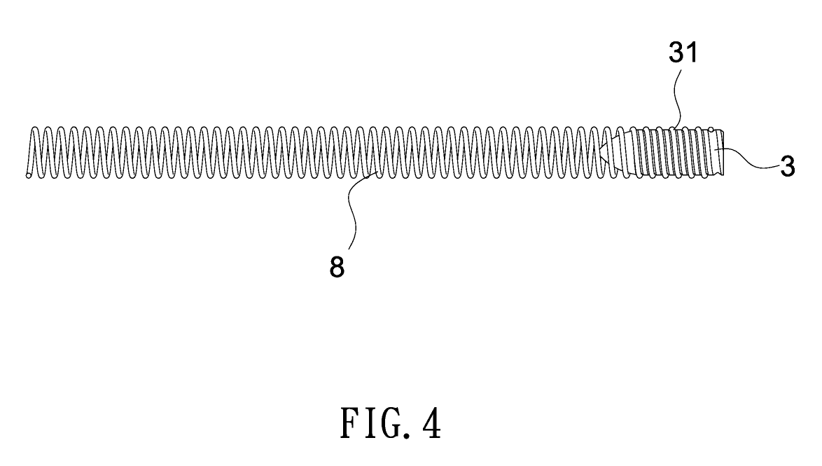

Referring to FIG. 4, the coil guiding block 3 is removably disposed on the housing 1 and at the end of the path of the inclined guiding comb tooth 11. The coil guiding block 3 is bullet-shaped and a spiral groove 31 is formed on the outer peripheral surface of the coil guiding block 3.

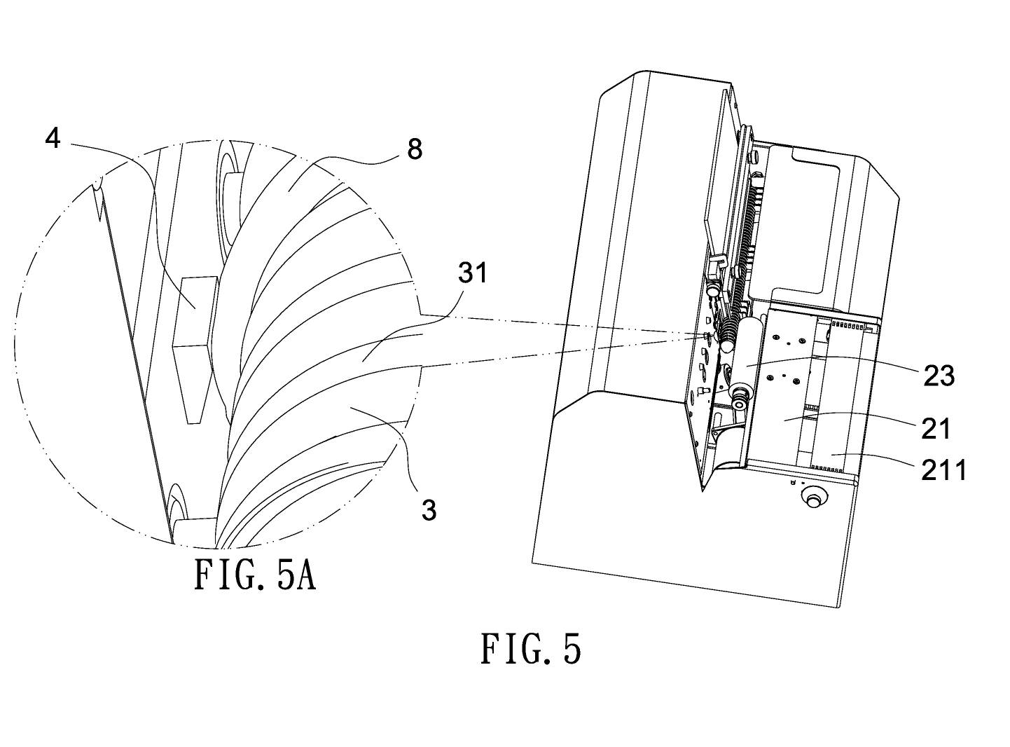

Referring to FIG. 5 and FIG. 5A, the coil sensor 4 is disposed on the housing 1 and located at the central position adjacent to the coil guiding block 3. Through the friction wheel 23 driving the coil 8 as well as the front end of the coil 8 contacting with the coil sensor 4 or the rear end of the coil 8 departing from the coil sensor 4, it is capable of controlling the friction wheel 23 of the conveying device 2 to stop rotating.

The conveying device 2 comprises a fastening frame 21, a starting motor 22, a friction wheel 23 and a belt pulley 24. The fastening frame 21 is disposed in the accommodating space at the left-front portion of the housing 1 and is able to reciprocatedly move forwards and backwards in the left-front portion of the housing 1. A plurality of limit perforations 211 are formed on the fastening frame 21 to engage with the limit gear 12 of the housing 1 for orientating the relative position of the fastening frame 21 and the housing 1 so as to adjust the coil conveying space of the friction wheel 23 and the inclined guiding comb tooth 11. The starting motor 22 is disposed on the fastening frame 21, the friction wheel 23 is disposed on the fastening frame 21, and the belt pulley 24 connects to the starting motor 22 and the friction wheel 23 therebetween so that the starting motor 22 drives the friction pulley 23 to rotate and stop through the transmission of the belt pulley 24.

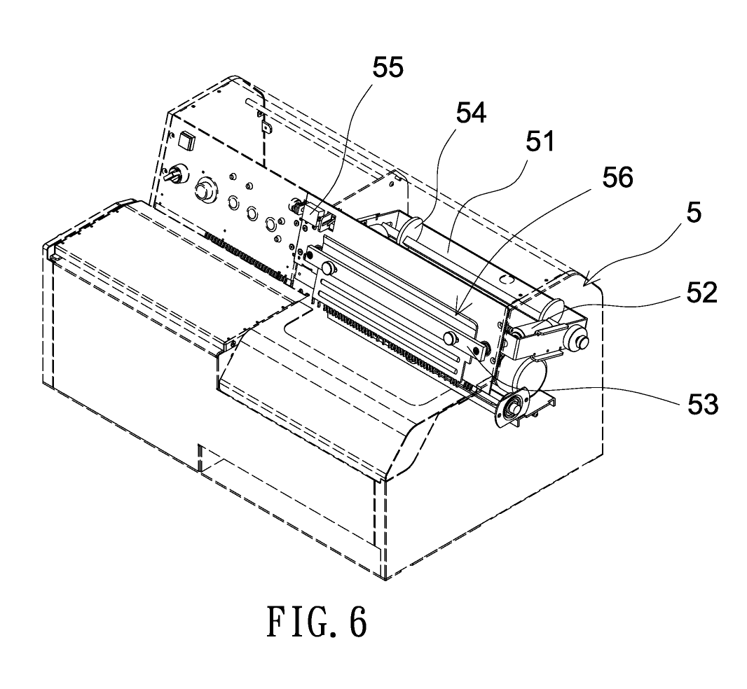

Referring to FIGS. 6-8, the clamping device 5 comprises a book clamping base 51, at least one magnet driver 52, a movable pressing board 53, a cam assembly 54 and a book clamping sensor 55. The book clamping base 51 is disposed at the accommodating space at the right-rear side of the housing 1 and has two fixing lateral sides. The magnet driver 52 is disposed on the two fixing lateral sides of the book clamping base 51. The movable pressing board 53 connects to the magnet driver 52. The movable pressing board 53 is driven to reciprocate between the clamping position and the releasing position through the magnet driver 52. The cam assembly 54 is disposed on the housing 1 to rotate without displacements under the control of the external force. Through the cam assembly 54 fine adjusting the book clamping base 51 and simultaneously driving the movable pressing board 53, a book clamping space 56 is formed between the movable pressing board 53 and the housing 1. The cam assembly 54 is utilized to adjust the scale of the book clamping space 56. A book clamping sensor 55 is disposed on the housing 1 at a side of the book clamping space 56.

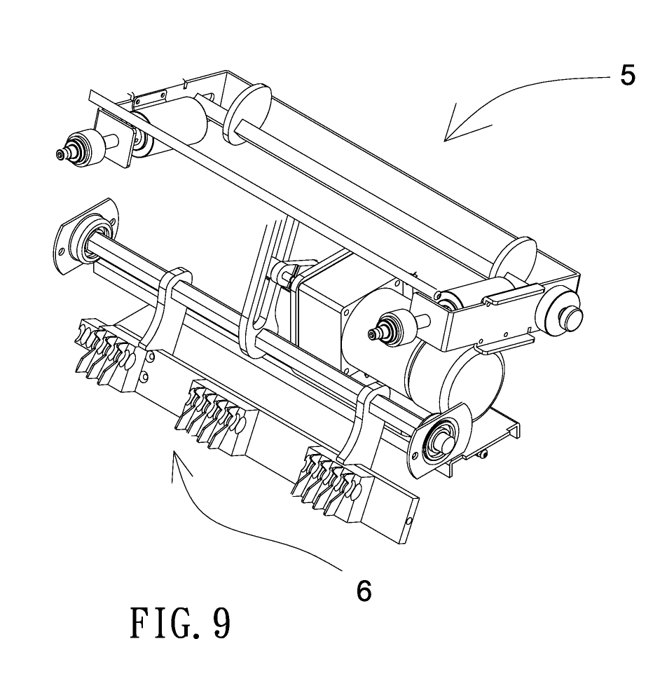

Referring to FIGS. 9-11, the supporting apparatus 6 has an elevating motor 61, a driven shaft 62, an elevating base 63 and a plurality of supporting guiding blocks 64. The elevating motor 61 is disposed in the right-rear bottom accommodating space of the housing 1. The driven shaft 62 connects to the elevating motor 61. The elevating base 63 connects to the driven shaft 62 so as to be driven by the driven shaft 62 to reciprocatedly swing between a supporting position and a loosening position. The supporting guiding blocks 64 are removably disposed on the elevating base 63 and are arranged with predetermined intervals therebetween. A plurality of cambered convexities 641 are arranged in parallel with predetermined intervals therebetween on the top surface of the supporting guiding block 64, and a cambered concave 642 is formed between the adjacent cambered convex supporting guiding blocks.

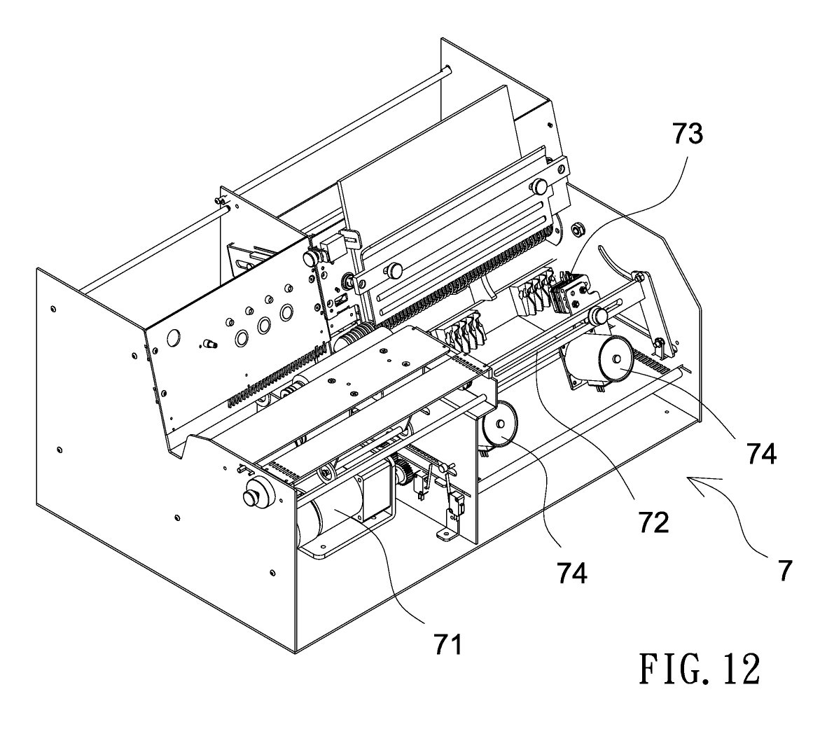

Referring to FIGS. 12-15, the cutting apparatus 7 has an electric motor 71, a cutting base 72, two cutters 73, two synchronous motors 74 and a cutting sensor 75. The electric motor 71 is disposed on the housing 1. The cutting base 72 connects to the electric motor 71 so as to be driven by the electric motor 71 to reciprocatedly move between a cutting position and a preparing position. The two cutters 73 are disposed on the cutting base 72 and the interval therebetween is adjustable. The two synchronous motors 74 are disposed on the cutting base 72 and connect to the cutters 73. Through adjusting the location of the cutting sensor 75, the cutters 73 are driven to perform the cutting operations.

The foregoing disclosures relate to the structures and the assembling manners of the book coil binding machine in the preferred embodiment of the present invention. The using characteristics of the machine are disclosed hereinafter.

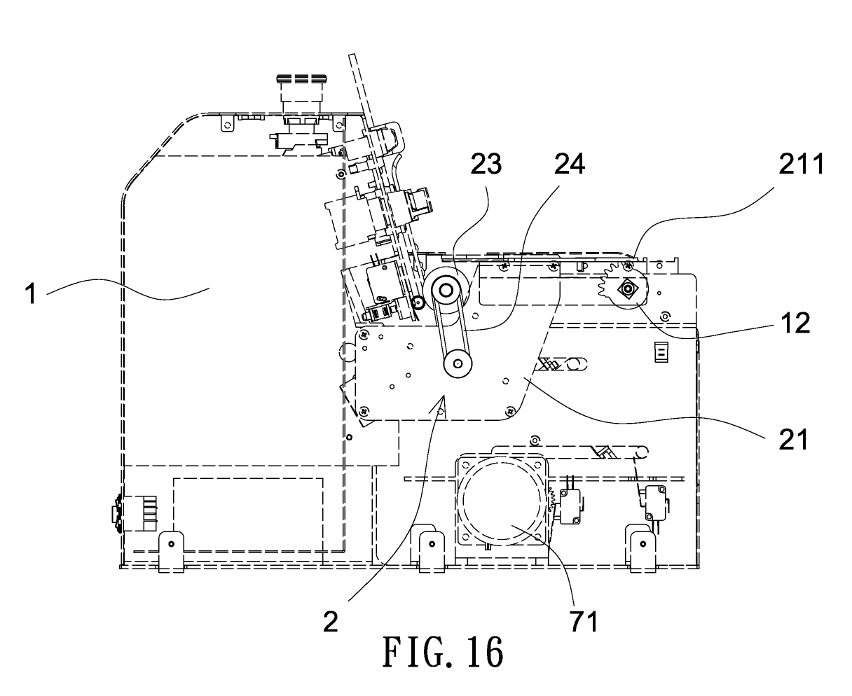

First, the conveying device 2 moves to adjust the position according to the outer diameter of the coil 8 which is going to be used for binding. That is, after the limit gear 12 departs from the limit perforations 211, the fastening frame 21 is then moved to an appropriate position (as shown in FIG. 16). The friction wheel 23 is certainly located at a position where is able to contact to the coil 8. The limit gear 12 is then engaged with the limit perforations 211 again.

Before the binding procedure, the elevating base 63 of the supporting apparatus 6 is located at the supporting position.

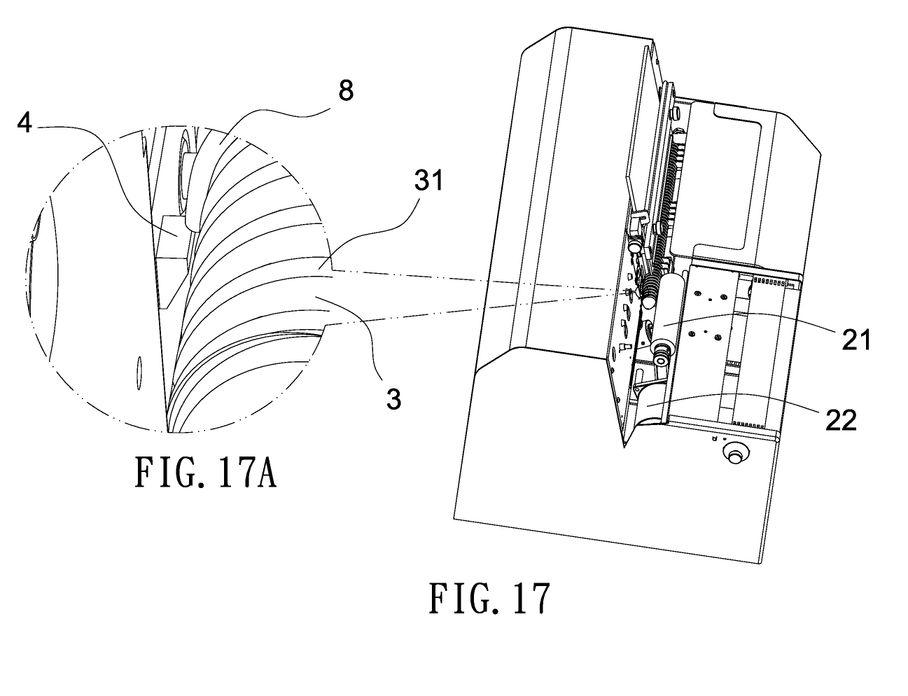

Then, the coil 8 (as shown in the FIG. 4) is frictionally delivered by the friction wheel 23 and moves along the guiding comb tooth 11 (as shown in FIG. 1). After the coil 8 is guided to the spiral groove 31 on the coil guiding block 3, the ends of the coil 8 would contact onto the coil sensor 4 (as shown in FIG. 17) so as to render the friction wheel 23 stop.

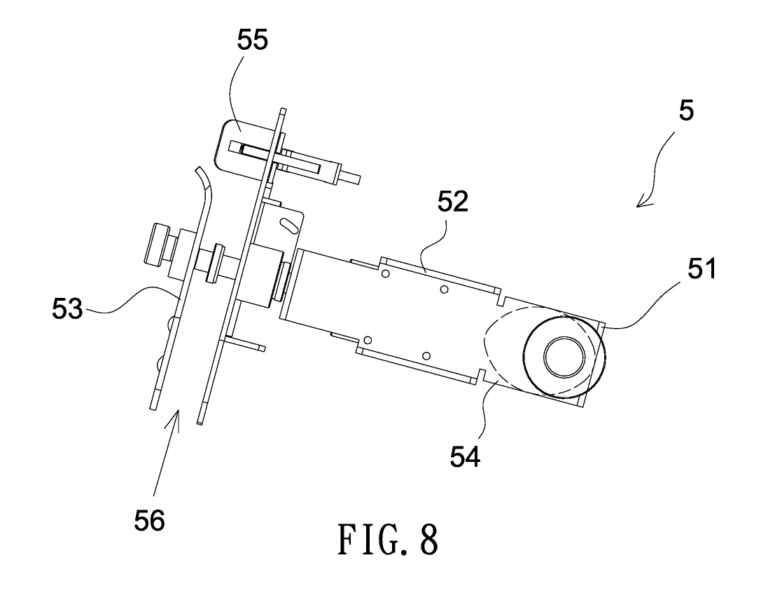

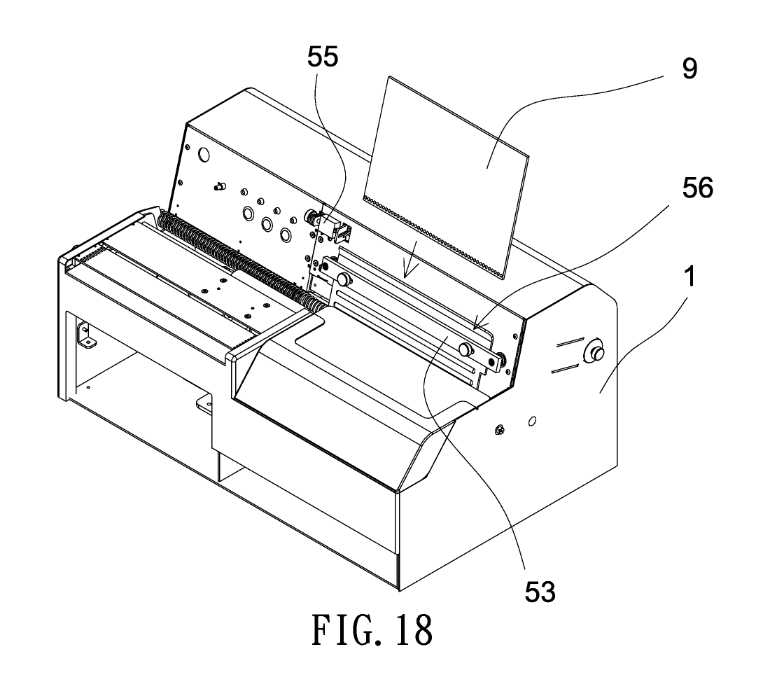

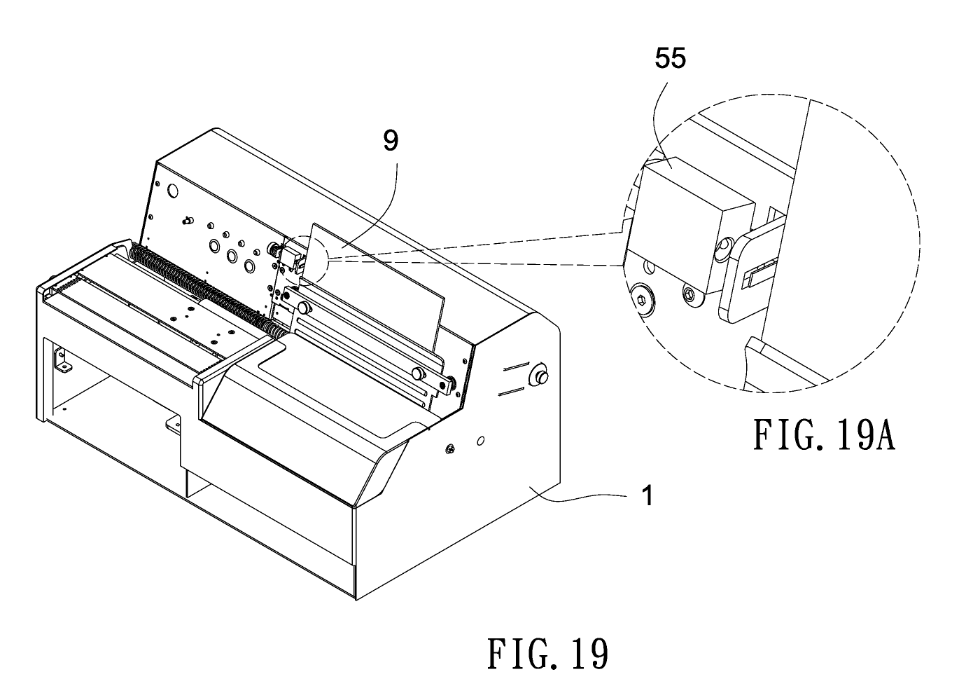

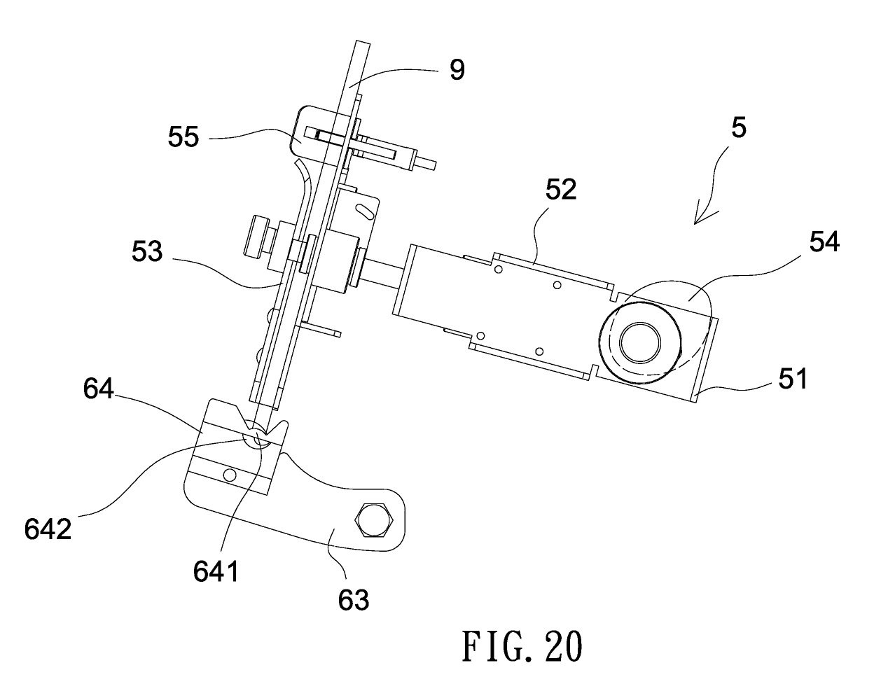

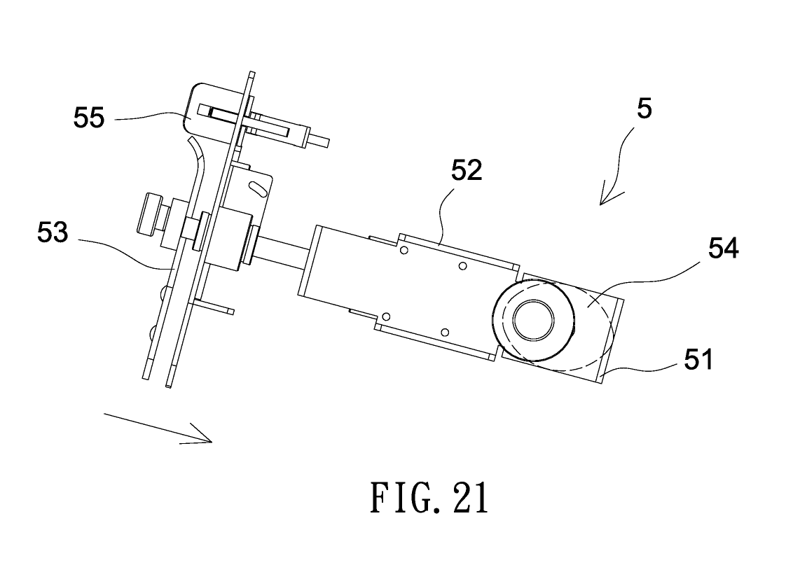

At this time, the book 9 has the holes and is ready to be bound would be able to be disposed into the book clamping space 56 of the clamping device 5 (as shown in FIG. 18 and FIG. 19). The book 9 is abutted and supported onto the cambered convexities 641 of the supporting guiding block 54 of the supporting apparatus 6 (as shown in FIG. 20). Due to the configurations of the cambered convexities 641, the holes of the book 9 are cambered for facilitating the coil 8 being guided therein. When the book 9 is located into the book clamping space 56, the user simultaneously move the book 9 to contact with the book clamping sensor 55. Thus, the movable pressing board 53 is driven by the cam assembly 54 through the book clamping base 51 and the magnet driver 52 and moves from the releasing position (as shown in FIG. 8) to the clamping position (as shown in FIG. 21).

Furthermore, in the meantime of the book 9 being located into the book clamping space 56 and contacting onto the book clamping sensor 55, the friction wheel 23 would be driven again to drive the coil 8 continuously passing through the holes of the book 9 by the guidance of the inclined guiding comb tooth 11, the spiral groove 31 of the coil guiding block 3, and the cambered concave 642 of the supporting apparatus 6. After the other end of the coil 8 passes through the coil sensor 4 and completely passes through the holes of the book 9, the coil sensor 4 terminates the rotation of the friction wheel 23 again to stop the coil 8 from moving forwards.

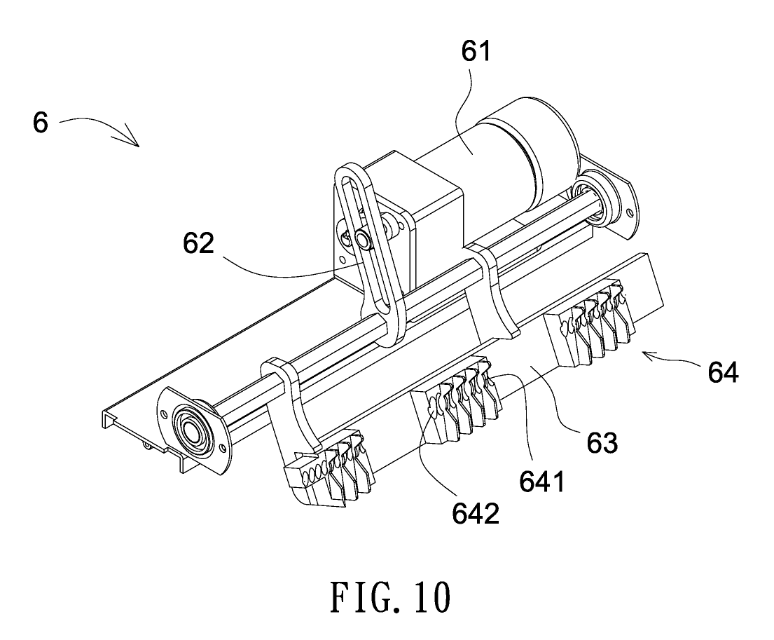

In the meantime, the elevating base 63 is driven by the elevating motor 61 through the driven shaft 62 to swing from the supporting position to the loosening position (as shown in FIG. 10).

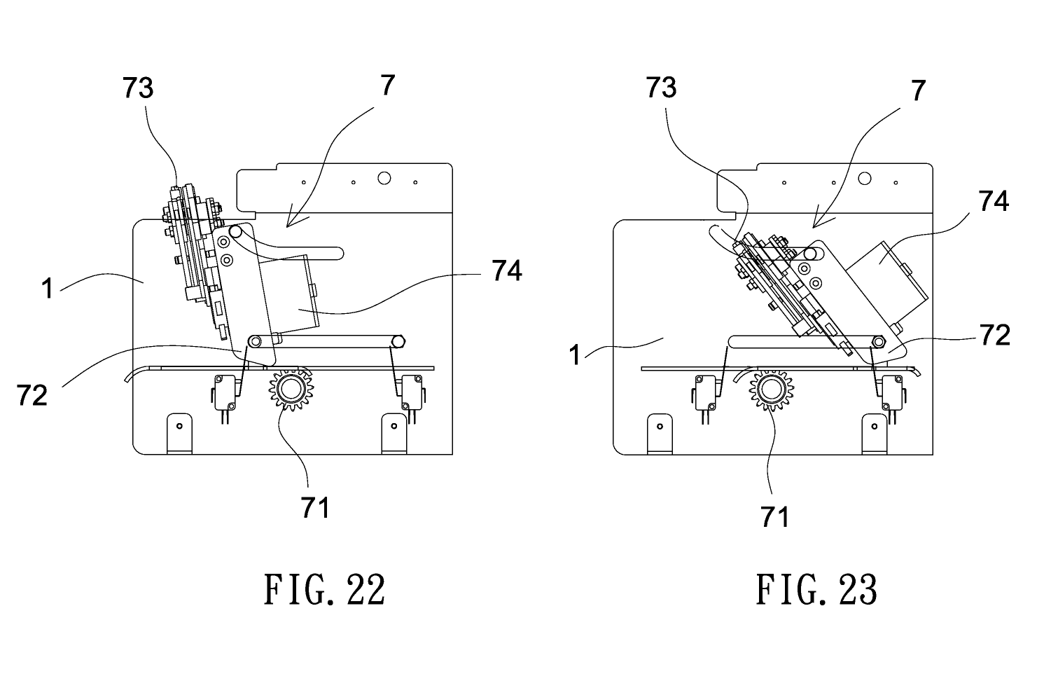

The electric motor 71 of the cutting apparatus 7 also drives the cutting base 72 from the preparing position (as shown in FIG. 22) to the cutting position (as shown in FIG. 23). The synchronous motors 74 drive the cutters 73 to cut off the two ends of the coil 8 which are extended out of the book 9. After that, the cutting base 72 would be lead to the preparing position again.

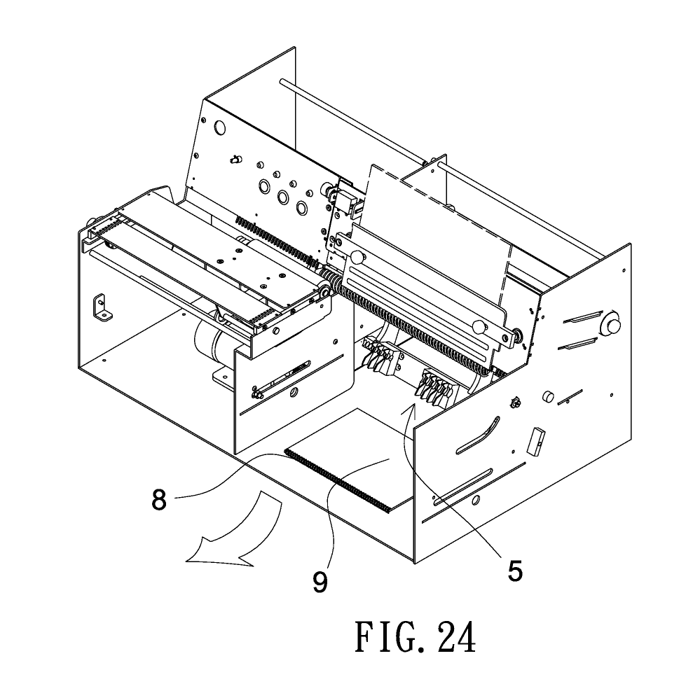

The movable pressing board 53 of the clamping device 5 moves from the clamping position to the releasing position, so that the book 9 bound with the coil 8 would slip out the book clamping space 56 (as shown in FIG. 24) for the collection. The elevating base 63 of the supporting apparatus 6 would move to the supporting position again to wait for the next binding procedure.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A book coil binding machine, comprising:
a housing having an inclined guiding comb tooth disposed at a left side thereof;
a coil guiding block being removably disposed on the housing and at a path end of the inclined guiding comb tooth, the coil guiding block being formed with a spiral groove on an outer peripheral surface thereof;
a coil sensor being disposed on the housing and located at a central position adjacent to the coil guiding block, the coil sensor being utilized to control initiation and termination of a conveying device;
the conveying device being disposed on a left-front portion of the housing and driven by a starting motor through a belt pulley to drive a friction wheel to rotate, so as to drive a coil moving forwards along the guiding comb tooth and the spiral groove of the coil guiding block;
a clamping device being disposed in an accommodating space at a right-rear side of the housing, the clamping device having a book clamping space for accommodating a book, wherein the clamping device is capable of reciprocatedly moving between a clamping position and a releasing position so as to clamp the book in the book clamping space for the coil being guided into holes of the book when the clamping device is at the clamping position and to release the book in the book clamping space when the clamping device is at the releasing position;
a supporting apparatus being disposed in an accommodating space at a right-rear bottom side of the housing and pivotally and reciprocatedly swinging between a supporting position and a loosening position, wherein the supporting apparatus is provided for the book in the book clamping space being abutted thereto when the supporting apparatus is at the supporting position and the supporting apparatus is departed from the book in the book clamping space when the supporting apparatus is at the loosening position; and
a cutting apparatus being disposed in a right-front portion of the housing, wherein the cutting apparatus is capable of reciprocatedly moving between a cutting position and a preparing position, wherein the cutting apparatus cuts off two ends of the coil which are extended out of the book when the cutting apparatus is at the cutting position.

2. The book coil binding machine as claimed in claim 1, wherein the clamping device comprises a book clamping base, at least one magnet driver, a movable pressing board and a cam assembly, wherein the book clamping base has two fixing lateral sides, the magnet driver is disposed on the two fixing lateral sides of the book clamping base, the movable pressing board connects to the magnet driver to recipracatedly move between a clamping position and a releasing position through the magnet driver, and the cam assembly is disposed on the housing to immovably rotate under the control of the external force, and the movable pressing board is driven to reciprocatedly move between the clamping position and the releasing position through the cam assembly and the magnet driver.

3. The book coil binding machine as claimed in claim 1, wherein the supporting apparatus has an elevating motor, a driven shaft, an elevating base and at least one supporting guiding block, wherein the elevating motor is disposed in the housing, the driven shaft connects to the elevating motor, the elevating base connects to the driven shaft so as to be driven by the driven shaft to reciprocatedly swing between a supporting position and a loosening position, the supporting guiding block is removably disposed on the elevating base on which a plurality of cambered convexities are arranged in parallel with predetermined intervals therebetween and a cambered concave is formed between the adjacent cambered convexities.

4. The book coil binding machine as claimed in claim 1, wherein the book is capable of being disposed in the book clamping space of the clamping device, the book being supported from and abutted to the cambered convexities of the supporting guiding block of the supporting apparatus so that the book and holes thereof are cambered due to the cambered convexities to facilitate the coil being guided in the holes.

5. The book coil binding machine as claimed in claim 1, wherein the movable pressing board is driven to move from the loosening position to the clamping position by the cam assembly through the book clamping base and the magnet driver when the book is disposed into the book clamping space; simultaneously, the friction wheel being driven again to drive the coil through the guidance of the inclined guiding comb tooth, the spiral groove of the coil guiding block, and the cambered concave of the supporting apparatus, to continuously pass through the holes of the book.
